(19) United States
(12) Patent Application Publication
(10) Pub. No.: US 2015/0048559 A1
(43) Pub. Date: Feb. 19, 2015

(54) MOLD MANUFACTURING METHOD, MOLD MANUFACTURING APPARATUS, AND PATTERN FORMATION METHOD

(71) Applicant: Kabushiki Kaisha Toshiba, Tokyo (JP)

(72) Inventors: Sachiko KOBAYASHI, Tokyo (JP); Satoshi Tanaka, Kanagawa-ken (JP); Kazuhiro Takahata, Mie-ken (JP)

(73) Assignee: Kabushiki Kaisha Toshiba, Tokyo (JP)

(21) Appl. No.: 14/180,864

(22) Filed: Feb. 14, 2014

(30) Foreign Application Priority Data
Aug. 15, 2013 (JP) 2013-168916

(51) Int. Cl. B29C 59/02

(52) U.S. Cl. CPC B29C 59/022
USPC 264/496; 264/40.1; 425/141

(57) ABSTRACT

According to one embodiment, a mold manufacturing method includes obtaining a first distribution, obtaining a second distribution, generating a correction data, and forming a second mold. The first distribution is a distribution of level difference included in a first layer on a substrate. The obtaining the second distribution obtains the second distribution when a first mold having the concave-convex pattern is brought into contact with a photosensitive resin applied on the first layer and the resin is cured. The second distribution is a distribution of film thickness of the resin remaining between the substrate and a convex pattern feature of a concave-convex pattern. The correction data is a data for suppressing a difference between one of the first distribution and the second distribution, and a film thickness of a reference set beforehand. The second mold is different from the first mold using the correction data.

### CROSS-REFERENCE TO RELATED APPLICATIONS

This application is based upon and claims the benefit of priority from Japanese Patent Application No. 2013-168916, filed on Aug. 15, 2013; the entire contents of which are incorporated herein by reference.

### FIELD

Embodiments described herein relate generally to a mold manufacturing method, a mold manufacturing apparatus, and a pattern formation method.

### BACKGROUND

As a method for forming a fine pattern, there is an imprint method using a master plate (mold) provided with an concave-convex pattern corresponding to the configuration of a pattern to be formed. In the imprint method, a photocurable organic material (photosensitive resin), for example, is applied onto a substrate and a mold is brought into contact with the layer of the organic material. Then, in this state the organic material is irradiated with light (e.g. ultraviolet light) to cure the organic material, and then the mold is separated from the organic material. Thereby, the configuration of the concave-convex pattern of the mold is transferred to the layer of the organic material. In the imprint method, a pattern excellent in dimension uniformity is formed at low cost. In the method for forming a pattern using a mold, it is important to suppress the influence of a level difference of an underlayer.

### BRIEF DESCRIPTION OF THE DRAWINGS

FIG. 1 is a flow chart illustrating a mold manufacturing method according to a first embodiment;

FIG. 2A to FIG. 2D are schematic cross-sectional views illustrating a pattern formation method by the imprint method;

FIG. 3A to FIG. 3D are schematic cross-sectional views illustrating an imprint method according to a reference example;

FIG. 4A to FIG. 4E are schematic views illustrating a specific example;

FIG. 5A to FIG. 5F are schematic cross-sectional views illustrating molds;

FIG. 6A to FIG. 6C are schematic cross-sectional views showing examples of the pattern formation using the second mold;

FIG. 7 is a block diagram illustrating a mold manufacturing apparatus according to the second embodiment;

FIG. 8 is a flow chart illustrating a pattern formation method according to the third embodiment;

FIG. 9A and FIG. 9B are schematic cross-sectional views illustrating adjustments of the bending of the mold;

FIG. 10 is a schematic view illustrating a pattern formation apparatus according to the fourth embodiment; and

FIG. 11 is a diagram illustrating the hardware configuration of a computer.

### DETAILED DESCRIPTION

In general, according to one embodiment, a mold manufacturing method includes obtaining a first distribution, obtaining a second distribution, generating a correction data, and forming a second mold. The first distribution is a distribution of level difference included in a first layer on a substrate. The obtaining the second distribution obtains the second distribution when a first mold having the concave-convex pattern is brought into contact with the photosensitive resin applied on the first layer including and the photosensitive resin is cured. The second distribution is a distribution of film thickness of a photosensitive resin remaining between the substrate and a convex pattern feature of a concave-convex pattern. The correction data is a data for suppressing a difference between one of the first distribution and the second distribution, and a film thickness of a reference set beforehand. The second mold is different from the first mold using the correction data.

Various embodiments will be described hereinafter with reference to the accompanying drawings. In the following description, identical components are marked with the same reference numerals, and a description of components once described is omitted as appropriate.

### First Embodiment

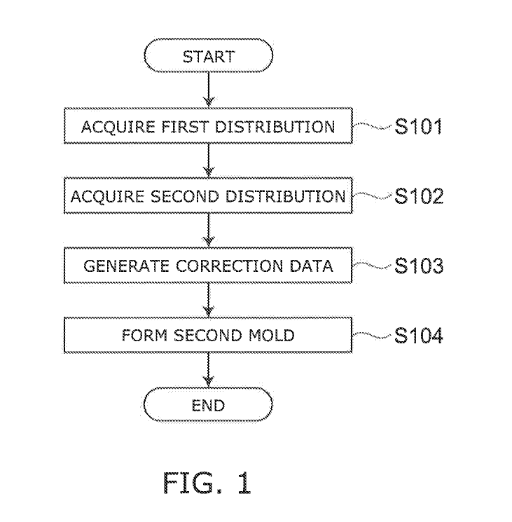

FIG. 1 is a flow chart illustrating a mold manufacturing method according to a first embodiment.

The mold manufactured in the embodiment is a master plate used in the imprint method. The mold has a concave-convex pattern corresponding to the configuration of a pattern to be formed.

As shown in FIG. 1, the mold manufacturing method according to the embodiment includes the acquisition of a first distribution (step S101), the acquisition of a second distribution (step S102), the generation of correction data (step S103), and the formation of a second mold (step S104).

First, in the acquisition of a first distribution (step S101), a first distribution that is the distribution of level difference included in a layer (first layer) on a substrate is obtained. The layer on the substrate is a layer serving as an underlayer on which a pattern will be formed by the imprint method. In the embodiment, the layer on the substrate is referred to as an “underlayer.” An underlayer pattern of a plurality of layers are formed on the underlayer, for example. A distribution of level difference (height difference) of the underlayer will occur due to the configuration, sparseness and denseness, etc. of the underlayer pattern. In the acquisition of a first distribution (step S101), a first distribution that is the distribution of level difference of the underlayer is obtained. In the embodiment, the layer on the substrate (underlayer) includes a layer including a surface of the substrate. In the embodiment, the underlayer includes a film on which a pattern will be formed by the imprint method (for example, an insulating film, a metal film (a conductive film), and a semiconductor film).

Next, in the acquisition of a second distribution (step S102), a second distribution is obtained that is the distribution of film thickness of a photosensitive resin remaining between the substrate and the convex pattern feature of the concave-convex pattern of a mold. When forming a pattern by the imprint method, a photosensitive resin is applied onto the underlayer of the substrate, and a mold is brought into contact with the photosensitive resin. Then, in this state the photosensitive resin is cured by light irradiation.

Here, when the mold is brought into contact with the photosensitive resin, a small space is provided between the underlayer of the substrate and the convex pattern feature of the concave-convex pattern of the mold. Between the underlayer and the mold, the photosensitive resin gets in the concave pattern feature and in the space between the convex pattern feature and the underlayer. After the photosensitive resin is cured, when the mold is separated from the photosensitive resin, the photosensitive resin that has been in the concave pattern feature and in the space between the convex pattern feature and the underlayer is left on the substrate. The second distribution is the distribution of film thickness of the photosensitive resin left in the space between the convex pattern feature and the underlayer. The second distribution is determined by the first distribution, which is the distribution of level difference of the underlayer, and conditions such as the stress applied to the mold.

In the acquisition of a second distribution (step S102), the distribution of film thickness of the photosensitive resin left in the space between the convex pattern feature and the underlayer is obtained. In the acquisition of a second distribution (step S102), a mold of a reference used in the imprint method is taken as a first mold. The first mold may be a mold as design data or a mold as a real entity. A second distribution when the first mold is brought into contact with a photosensitive resin is obtained.

Next, in the generation of correction data (step S103), correction data are generated that suppress the difference between one of the first distribution and the second distribution, and the film thickness of the reference set beforehand. The film thickness of the reference set beforehand is a fixed film thickness, for example. That is, when forming a pattern in the imprint method, the film thickness of the photosensitive resin left in the space between the convex pattern feature of the mold and the underlayer is preferably fixed. The film thickness of the reference is set to the fixed film thickness.

In the generation of correction data (step S103), first, the difference between one of the first distribution and the second distribution, and the film thickness of the reference is found. Then, correction data that can suppress (for example, offset) the difference are generated.

Next, in the production of a second mold (step S104), the correction data are used to form a second mold different from the first mold. That is, in the production of a second mold (step S104), based on the correction data, the configuration etc. of the first mold, which is a mold of a reference, are corrected and a second mold is produced. In the embodiment, the second mold may be a mold as design data or a mold as a real entity. In the case where a second mold as design data is produced, the mold manufacturing method is at the same time a mold design method.

When a pattern is formed by the imprint method using the second mold, the difference between the film thickness of the photosensitive resin remaining in the space between the convex pattern feature and the underlayer and the film thickness of the reference is suppressed as compared to the case where the first mold is used. That is, the second mold is a mold that has undergone correction of correcting the variation in the film thickness of the photosensitive resin shown by the second distribution. Thus, by forming a pattern by the imprint method using the second mold, the variation in the film thickness of the photosensitive resin remaining in the space between the convex pattern feature and the underlayer is suppressed.

Here, a sequence of the pattern formation method by the imprint method is described.

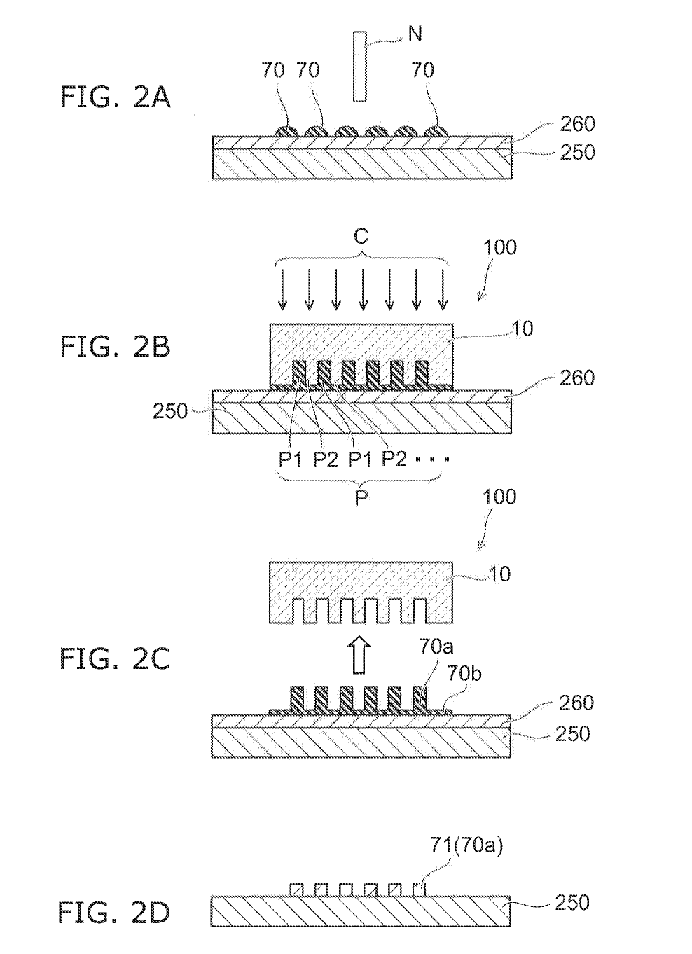

FIG. 2A to FIG. 2D are schematic cross-sectional views illustrating a pattern formation method by the imprint method.

First, as shown in FIG. 2A, a photosensitive resin 70 is applied onto an underlayer 260 on a substrate 250. A resist is used as the photosensitive resin 70, for example. The photosensitive resin 70 is applied onto the substrate 250 by the ink jet method from a nozzle N, for example. The size of the liquid drop of the photosensitive resin 70 is approximately several micrometers, for example. The spacing between liquid drops of the photosensitive resin 70 is not less than 10 μm and not more than 1000 μm, for example. The resist photosensitive resin may be applied with a uniform thickness on the underlayer 260 by spin coating or the like.

Next, as shown in FIG. 2B, a mold 100 is prepared. The mold 100 includes a base 10 and a pattern portion P provided on one surface side of the base 10. The pattern portion P is provided with concave pattern features P1 and convex pattern feature P2. Then, the pattern portion P of the mold 100 is brought into contact with the photosensitive resin 70. The photosensitive resin 70 enters the concave pattern feature P1 due to capillarity. Thereby, the inside of the concave pattern feature P1 is filled with the photosensitive resin 70. The photosensitive resin 70 enters also the space between the convex pattern feature P2 and the underlayer 260.

Next, in the state where the pattern portion P of the mold 100 is kept in contact with the photosensitive resin 70, light C is applied from the base 10 side of the mold 100. The light C is ultraviolet light, for example. The light C is transmitted through the base 10 and the pattern portion P, and is applied to the photosensitive resin 70. The photosensitive resin 70 is cured by the irradiation with light C.

Next, as shown in FIG. 2C, the mold 100 is separated from the photosensitive resin 70. Thereby, a transfer pattern 70a in which the concave-convex configuration of the pattern portion P of the mold 100 is transferred is formed on the underlayer 260. The photosensitive resin 70 that has entered the space between the convex pattern feature P2 of the mold 100 and the underlayer 260 remains as a residual film 70b after the curing.

Next, the transfer pattern 70a is used as a mask to etch the underlayer 260. Thereby, as shown in FIG. 2D, a pattern 71 corresponding to the configuration of the transfer pattern 70a is formed on the substrate 250.

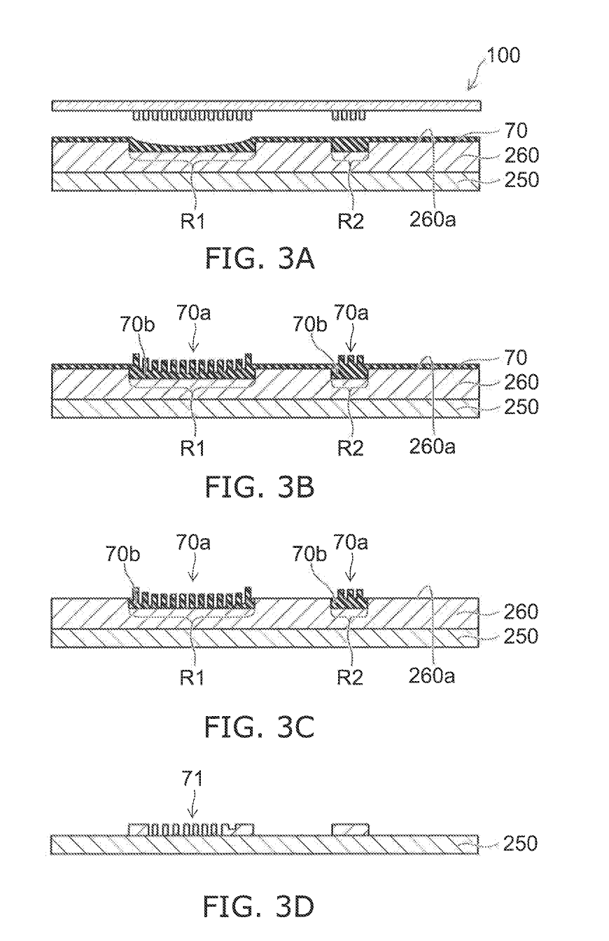

FIG. 3A to FIG. 3D are schematic cross-sectional views illustrating an imprint method according to a reference example.

The imprint method according to the reference example is an example in which a pattern is formed by the imprint method on an underlayer including level differences.

First, as shown in FIG. 3A, the photosensitive resin 70 is applied onto the underlayer 260 of the substrate 250. Level differences are included in the underlayer 260. For example, a level difference recessed further than the surface 260a of the underlayer 260 is included in a first region R1 and a second region R2 of the underlayer 260. The area of the first region R1 is larger than the area of the second region R2, for example. When the photosensitive resin 70 is applied onto the underlayer 260 including such level differences, a difference occurs in the film thickness of the photosensitive resin 70 due to the position, area, etc. of the region with a level difference.

For example, in the first region R1, the film thickness of the photosensitive resin 70 in the central portion of the first region R1 is thinner than the film thickness of the photosensitive resin 70 in the end portion (edge portion) of the first region R1. That is, in the first region R1, the film thickness of the photosensitive resin 70 becomes thicker from the central portion toward the end portion. In the second region R2 with a relatively small area, the photosensitive resin 70 is buried overall. Thus, the film thickness of the photosensitive resin 70 in the second region R2 is thicker than the film thickness of the photosensitive resin 70 on the surface 260a of the underlayer 260.

Next, the pattern portion P of the mold 100 is brought into contact with the photosensitive resin 70 like this, the photosensitive resin 70 is cured, and the mold 100 is separated from the photosensitive resin 70. Thereby, as shown in FIG. 3B, a transfer pattern 70a formed of the photosensitive resin 70 is formed on the underlayer 260. The distribution of film thickness of the photosensitive resin 70 shown in FIG. 3A is reflected on the thickness of the residual film 70b of the photosensitive resin 70 in the concave portions of the transfer pattern 70a formed on the underlayer 260.

Next, as shown in FIG. 3C, the transfer pattern 70a is used as a mask to perform etching. In the etching, the transfer pattern 70a is etched gradually, and after a while the underlayer 260 is etched. When etching proceeds further, as shown in FIG. 3D, a pattern 71 is formed on the substrate 250. At this time, the etching of portions with a large thickness of the residual film 70b is slow. The pattern 71 is not formed in these portions.

In the example shown in FIG. 3D, since the thickness of the residual film 70b is thick in the end portion of the first region R1 and in the second region R2, insufficient digging occurs in these portions. Consequently, defective portions occur where the pattern 71 is not formed accurately.

By using a mold manufactured by the embodiment, the variation in the thickness of the residual film 70b is suppressed. Thus, when a pattern is formed on the underlayer 260 including level differences by the imprint method, the pattern 71 is formed on the substrate 250 accurately by using the mold manufactured by the embodiment. In other words, the occurrence of defective portions where the pattern 71 is not formed is reduced. The dimension accuracy of the pattern 71 is improved, and an improvement in the performance of the device, an improvement in yield, and cost reduction are achieved.

Next, a specific example of the embodiment is described.

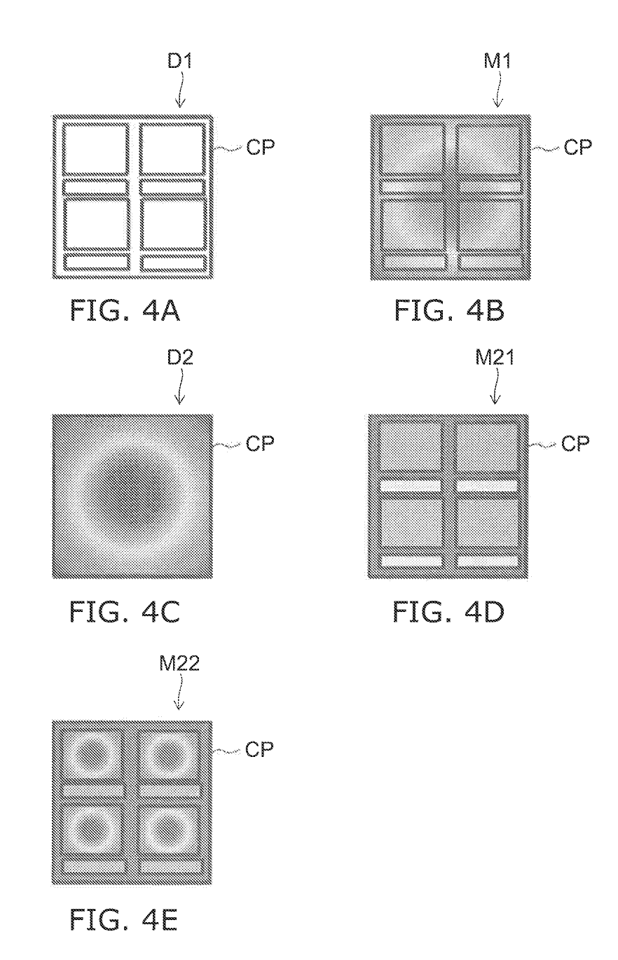

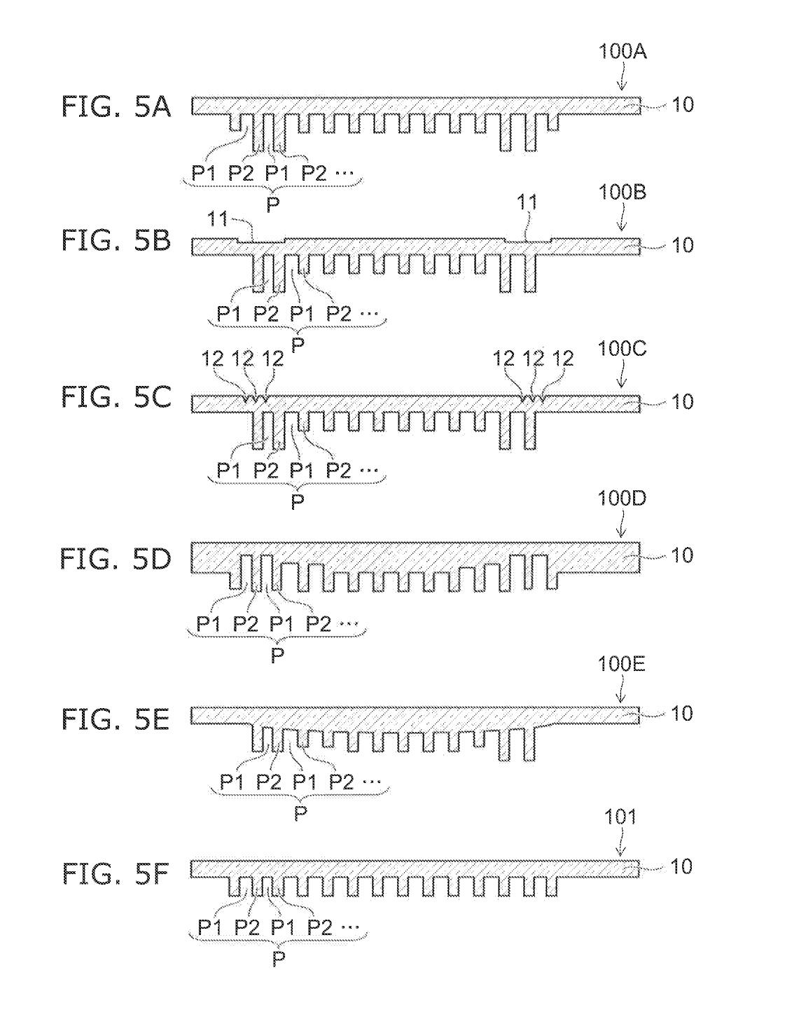

FIG. 4A to FIG. 4E are schematic views illustrating a specific example.

FIG. 4A to FIG. 4E schematically show a region CP corresponding to a rectangular chip.

First, in the process of obtaining a first distribution (step S101 of FIG. 1), design data D1 of an underlayer pattern like those shown in FIG. 4A are acquired. The design data D1 include the data of the layout in the chip region CP of the underlayer pattern.

Next, in the process of obtaining a first distribution (step S101 of FIG. 1), a level difference map M1 like that shown in FIG. 4B is obtained. The level difference map M1 shows the distribution of level difference amount in the region CP. The level difference amount in the region CP is found based on the design data D1 shown in FIG. 4A (for example, the data of the layout).

Next, in the process of obtaining a second distribution (step S102 of FIG. 1), the bending of the first mold like that shown in FIG. 4C is predicted. FIG. 4C shows the distribution D2 of bending amount of the first mold in the region CP. When forming a pattern by the imprint method, a prescribed stress is applied to the first mold. The distribution of bending amount of the first mold is found based on the stress.

Next, in the process of obtaining a second distribution (step S102 of FIG. 1), a level difference prediction map M21 like that shown in FIG. 4D is obtained. The level difference prediction map M21 is the distribution of predicted values of the film thickness of the residual film 70b of the photosensitive resin 70 in the region CP. The level difference prediction map M2 is an example of the second distribution.

The thickness of the residual film 70b in the region CP is predicted from the level difference map M1 shown in FIG. 4B and the distribution D2 of bending amount shown in FIG. 4C. FIG. 4E shows another level difference prediction map M22. The other level difference prediction map M22 is obtained when a distribution of bending amount different from the distribution D2 of bending amount is applied to one level difference map M1, for example.

Next, in the process of generating correction data (step S103 of FIG. 1), correction data that can suppress the predicted level difference are generated from one of the level difference prediction maps M21 and M22 shown in FIG. 4D and FIG. 4E. In the process of producing a second mold (step S104 of FIG. 1), the correction data are used to form a second mold different from the first mold. The second mold is a mold that has undergone correction of correcting the variation in the film thickness of the photosensitive resin shown by the second distribution (e.g. the level difference prediction maps M21 and M22).

In the process of obtaining a first distribution described above (step S101 of FIG. 1), the level difference of an underlayer formed on a substrate or an underlayer equivalent to that underlayer (a reference layer) may be measured beforehand, and the level difference map M1 may be predicted based on the measurement result. An AFM (atomic force microscope) is used for the measurement of the level difference, for example.

The level difference map M1 may be obtained by referring to table data that have been found beforehand. The table data are data that show the relationship between the position on the substrate in the reference layer and the measurement result of the level difference included in the reference layer.

In the process of obtaining a second distribution described above (step S102 of FIG. 1), it is also possible to measure and find the distribution of film thickness of a photosensitive resin that is formed by actually bringing the first mold into contact with the photosensitive resin (another example of the second distribution).

In the process of obtaining a second distribution described above (step S102 of FIG. 1), the level difference prediction map M2 may be obtained by simulation from design data of the first mold and conditions such as the stress applied to the first mold.

In the process of obtaining a second distribution described above (step S102 of FIG. 1), the stress applied to the first mold may be measured beforehand, and based on the measurement result, the spacing between the underlayer and the convex pattern feature may be predicted to obtain the level difference prediction map M2.

Next, examples of the mold are described.

FIG. 5A to FIG. 5F are schematic cross-sectional views illustrating molds.

FIG. 5A to FIG. 5E show the examples of second molds 100A to 100E produced in the process of producing a second mold (step S104 of FIG. 1). FIG. 5F shows the example of a first mold 101 as a reference.

The second molds 100A to 100E shown in FIG. 5A to FIG. 5E have a configuration in which the configuration of the first mold 101 shown in FIG. 5F is corrected by correction data.

In the second mold 100A shown in FIG. 5A, correction is made to the height of the convex pattern feature P2 in the pattern portion P. That is, in the second mold 100A, the thickness of the residual film 70b is adjusted by the height of the convex pattern feature P2. The height of the convex pattern feature P2 in the second mold 100A is higher in a portion where the level difference amount is larger in one of the level difference prediction maps M21 and M22.

In the second mold 100B shown in FIG. 5B, a rigidity adjustment portion 11 that reduces the rigidity of the base 10 is provided in part of the base 10. The rigidity adjustment portion 11 has a recess provided in the base 10, for example. The thickness of a portion of the base 10 where the recess is provided is thinner than the thickness of a portion of the base 10 where the recess is not provided. Thereby, the rigidity of the base 10 is decreased in the rigidity adjustment portion 11. When stress is applied to the second mold 100B in the imprint method, the rigidity adjustment portion 11 is bent largely. The position where the rigidity adjustment portion 11 is provided is determined based on the distribution of level difference amount in one of the level difference prediction maps M21 and M22. For example, the rigidity adjustment portion 11 is provided in a position of the base 10 corresponding to a portion where the level difference amount is large.

In the second mold 100C shown in FIG. 5C, a V trench 12 that reduces the rigidity of the base 10 is provided in part of the base 10. The rigidity of a portion of the base 10 where the V trench 12 is provided is lower than the rigidity of a portion where the V trench 12 is not provided. The rigidity is defined by the position, the depth, and the number of V trenches 12. The position, the depth, and the number of V trenches 12 are determined based on the distribution of level difference amount in one of the level difference prediction maps M21 and M22. For example, the V trench 12 is provided in a position of the base 10 corresponding to a portion where the level difference amount is large.

In the second mold 100D shown in FIG. 5D, correction is made to the depth of the concave pattern feature P1 in the pattern portion P. That is, in the second mold 100D, the thickness of the residual film 70b is adjusted by the depth of the concave pattern feature P1. The depth of the concave pattern feature P1 in the second mold 100D is deeper in a portion where the level difference amount is larger in one of the level difference prediction maps M21 and M22.

In the second mold 100E shown in FIG. 5E, correction is made to the thickness of the base 10. The depth of the concave pattern feature P1 is adjusted by the thickness of the base 10. In the second mold 100E, the thickness of the residual film 70b is adjusted by the thickness of the base 10. The thickness of the base 10 in the second mold 100E is thicker in a portion where the level difference amount is larger in one of the level difference prediction maps M21 and M22.

Features of the second molds 100A to 100E like those shown in FIG. 5A to FIG. 5E may be combined as appropriate.

As an example of forming the second mold different from the first mold using correction data, the second mold may be formed using a composition different from the composition of the first mold. For example, a composition having a higher flexibility than the first mold may be used as the composition of the second mold. Thereby, it becomes easy to make an adjustment to bend a portion of the second mold corresponding to a portion with a large thickness of the residual film 70b more largely than the other portions.

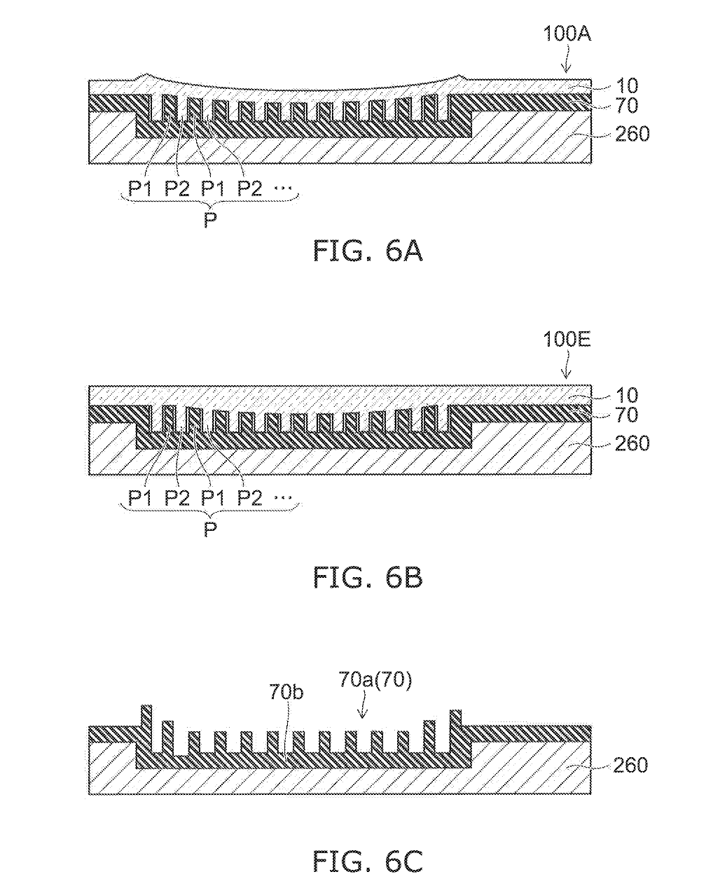

FIG. 6A to FIG. 6C are schematic cross-sectional views showing examples of the pattern formation using the second mold.

FIG. 6A shows a state where the second mold 100A shown in FIG. 5A is brought in contact with the photosensitive resin 70. FIG. 6B shows a state where the second mold 100E shown in FIG. 5E is brought in contact with the photosensitive resin 70. FIG. 6C shows a transfer pattern 70a formed.

As shown in FIG. 6A, when the second mold 100A is brought in contact with the photosensitive resin 70, the spacing between the convex pattern feature P2 of the second mold 100A and the underlayer 260 is equalized.

As shown in FIG. 6B, similarly, when the second mold 100E is brought in contact with the photosensitive resin 70, the spacing between the convex pattern feature P2 of the second mold 100E and the underlayer 260 is equalized.

When the second molds 100A and 100E are separated from the photosensitive resin 70, a transfer pattern 70a like that shown in FIG. 6C is formed. The thickness of the residual film 70b provided in the space between the convex pattern feature P2 and the underlayer 260 is more equalized than when the first mold 101 is used. When the transfer pattern 70a is used as a mask to perform etching, the variation in etching time between portions of the residual film 70b is suppressed. Consequently, a pattern 71 is formed surely.

### Second Embodiment

Next, a second embodiment is described.

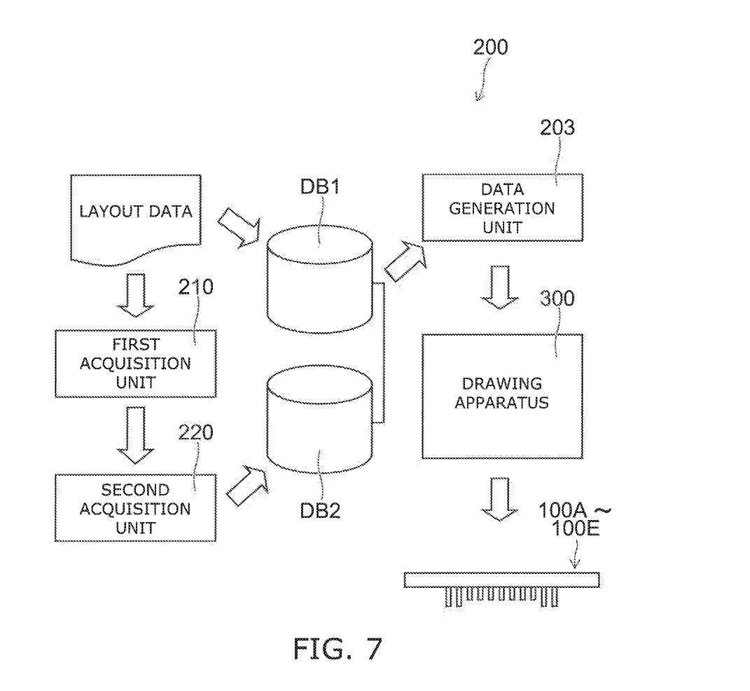

FIG. 7 is a block diagram illustrating a mold manufacturing apparatus according to the second embodiment.

As shown in FIG. 7, a mold manufacturing apparatus 200 according to the embodiment includes a first acquisition unit 210, a second acquisition unit 220, and a data generation unit 230.

The first acquisition unit 210 obtains a first distribution that is the distribution of level difference included in an underlayer on a substrate. The second acquisition unit 220 obtains a second distribution that is the distribution of film thickness of a photosensitive resin remaining between the substrate and the convex pattern feature of a mold. The data generation unit 230 generates data for forming a second mold different from the first mold.

The mold manufacturing apparatus 200 includes a computer, for example. The first acquisition unit 210, the second acquisition unit 220, and the data generation unit 230 may be connected to one another via a network. In this case, the first acquisition unit 210, the second acquisition unit 220, and the data generation unit 230 may be provided in a computer in one position, or may be provided to be distributed in a plurality of computers in different places.

The first acquisition unit 210 performs the processing of obtaining a first distribution shown in step S101 of FIG. 1. For example, the first acquisition unit 210 performs the processing of acquiring design data of the underlayer pattern (for example, layout data) and obtaining the level difference map M1. For example, the distribution of underlayer level difference structures for each layer is found by simulation from the stack layout data of the underlayer, and the distribution is mapped on the XY coordinate axes along the substrate surface to obtain the level difference map M1. The first acquisition unit 210 may obtain the level difference map M1 by calculation, such as simulation, or may acquire the level difference map M1 from the outside.

The second acquisition unit 220 performs the processing of obtaining a second distribution shown in step S102 of FIG. 1. For example, the second acquisition unit 220 performs the processing of obtaining the level difference prediction map M2 from the level difference map M1 obtained in the first acquisition unit 210 and the distribution D2 of bending amount of the first mold. The second acquisition unit 220 may obtain the level difference prediction map M2 by calculation, such as simulation, or may acquire the level difference prediction map M2 from the outside. The second acquisition unit 200 stores the data of the acquired level difference prediction map M2 (level difference prediction data) in a database DB2, for example.

The data generation unit 230 performs the processing of generating correction data shown in step S103 of FIG. 1. For example, correction data that can suppress the predicted level difference are generated from the level difference prediction map M2 obtained in the second acquisition unit 220. The correction data vary with the configuration of the second mold (for example, the configurations of the second molds 100A to 100E, as shown in FIG. 5A to FIG. 5E).

The correction data are sent to a drawing apparatus 300. The drawing apparatus 300 is an apparatus that applies an electron beam to a matrix such as a glass substrate to form concavities on the matrix. The drawing apparatus 300 adjusts the position of irradiation and the amount of irradiation of the electron beam based on drawing data stored in a database DB1 and the correction data sent from the data generation unit 230. Thereby, the second molds 100A to 100E shown in FIG. 5A to FIG. 5E are formed, for example.

The mold manufacturing apparatus 200 according to the embodiment is at the same time a mold design apparatus. At least one of the first acquisition unit 210, the second acquisition unit 220, and the data generation unit 230 may be incorporated as a part of the drawing apparatus 300. By including the drawing apparatus 300, the mold manufacturing apparatus 200 functions as an apparatus that manufactures the second mold as a real entity.

### Third Embodiment

Next, a third embodiment is described.

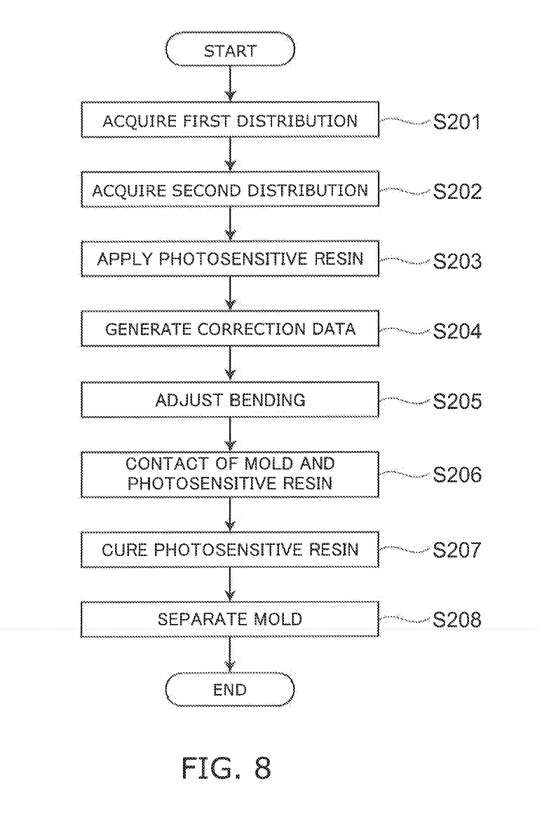

FIG. 8 is a flow chart illustrating a pattern formation method according to the third embodiment.

As shown in FIG. 8, the pattern formation method according to the embodiment includes the acquisition of a first distribution (step S201), the acquisition of a second distribution (step S202), the application of a photosensitive resin (step S203), the generation of correction data (step S204), the adjustment of bending (step S205), the contact of a mold and the photosensitive resin (step S206), the curing of the photosensitive resin (step S207), and the separation of the mold (step S208).

First, in the acquisition of a first distribution (step S201), a first distribution that is the distribution of level difference included in an underlayer on a substrate is obtained. The acquisition of a first distribution (step S201) is the same as the acquisition of a first distribution shown in FIG. 1 (step S101).

Next, in the acquisition of a second distribution (step S202), a second distribution is obtained that is the distribution of film thickness of a photosensitive resin remaining between the substrate and the convex pattern feature of the concave-convex pattern of a mold. The acquisition of a second distribution (step S202) is the same as the acquisition of a second distribution shown in FIG. 1 (step S102).

Next, in the application of a photosensitive resin (step S203), as shown in FIG. 2A, the processing of applying the photosensitive resin 70 onto the substrate 250 is performed.

Next, in the generation of correction data (step S204), correction data are generated that suppress the difference between one of the first distribution and the second distribution, and the film thickness of a reference set beforehand. The generation of correction data (step S204) is the same as the generation of correction data shown in FIG. 1 (step S103).

Next, in the adjustment of bending (step S205), the processing of using the correction data generated in step S204 to adjust the bending of the mold is performed. For example, in a portion where the difference between the film thickness of the photosensitive resin and the film thickness of the reference is large in the correction data, the bending amount of the mold corresponding to that portion is increased.

Next, in the contact of a mold and the photosensitive resin (step S206), the mold that has been adjusted in bending and the photosensitive resin are brought into contact. When the mold adjusted in bending is brought into contact with the photosensitive resin, the spacing between the convex pattern feature of the mold and the underlayer is equalized.

Next, in the curing of the photosensitive resin (step S207), the photosensitive resin is irradiated with light (e.g. ultraviolet light) in the state where the mold adjusted in bending and the photosensitive resin are kept in contact. The photosensitive resin is cured by the light irradiation.

Next, in the separation of the mold (step S208), the mold is separated from the photosensitive resin. Thereby, a transfer pattern in which the concave-convex configuration of the pattern portion of the mold is transferred is formed on the substrate. The photosensitive resin that has entered the space between the convex pattern feature of the mold and the underlayer remains as a residual film after the curing.

After that, the transfer pattern is used as a mask to perform etching. Thereby, a pattern is formed on the substrate.

In the pattern formation method according to the embodiment, since the bending of the mold is adjusted based on the correction data and the adjusted mold is brought into contact with the photosensitive resin, the difference between the film thickness of the photosensitive resin remaining in the space between the convex pattern feature and the underlayer and the film thickness of the reference is suppressed as compared to the case where the bending of the mold is not adjusted.

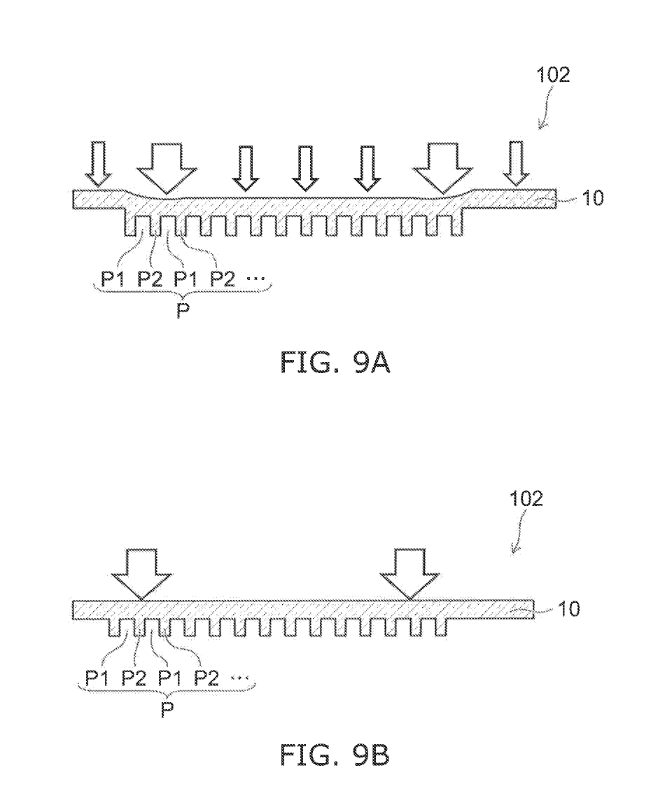

FIG. 9A and FIG. 9B are schematic cross-sectional views illustrating adjustments of the bending of the mold.

In the examples shown in FIG. 9A and FIG. 9B, the adjustment of bending is made by the pressure applied to a mold 102.

In the example shown in FIG. 9A, the pressure applied to the mold 102 is provided with a strength variation in accordance with positions in the mold 102. In FIG. 9A, the size of the arrow indicates the level of pressure. For example, in a portion where the difference between the film thickness of the photosensitive resin and the film thickness of the reference is large in the correction data, the pressure on a position in the mold corresponding to that portion is made higher than that on the other positions. In the position with a high pressure, the bending amount of the mold 102 is large.

In the example shown in FIG. 9B, the time in which pressure is applied to the mold 102 is adjusted. In FIG. 9B, pressure is applied to the portions shown by the arrows for a longer time than to the other portions. For example, in a portion where the difference between the film thickness of the photosensitive resin and the film thickness of the reference is large in the correction data, pressure is applied to a position in the mold corresponding to that portion for a longer time than to the other positions. In the portion to which pressure is applied for a long time, the bending amount of the mold 102 is large.

Thus, by adjusting the bending of the mold 102, the difference between the film thickness of the photosensitive resin remaining in the space between the convex pattern feature and the underlayer and the film thickness of the reference is suppressed as compared to the case were the bending of the mold is not adjusted. Thus, the defectiveness of the pattern is reduced.

### Fourth Embodiment

Next, a fourth embodiment is described.

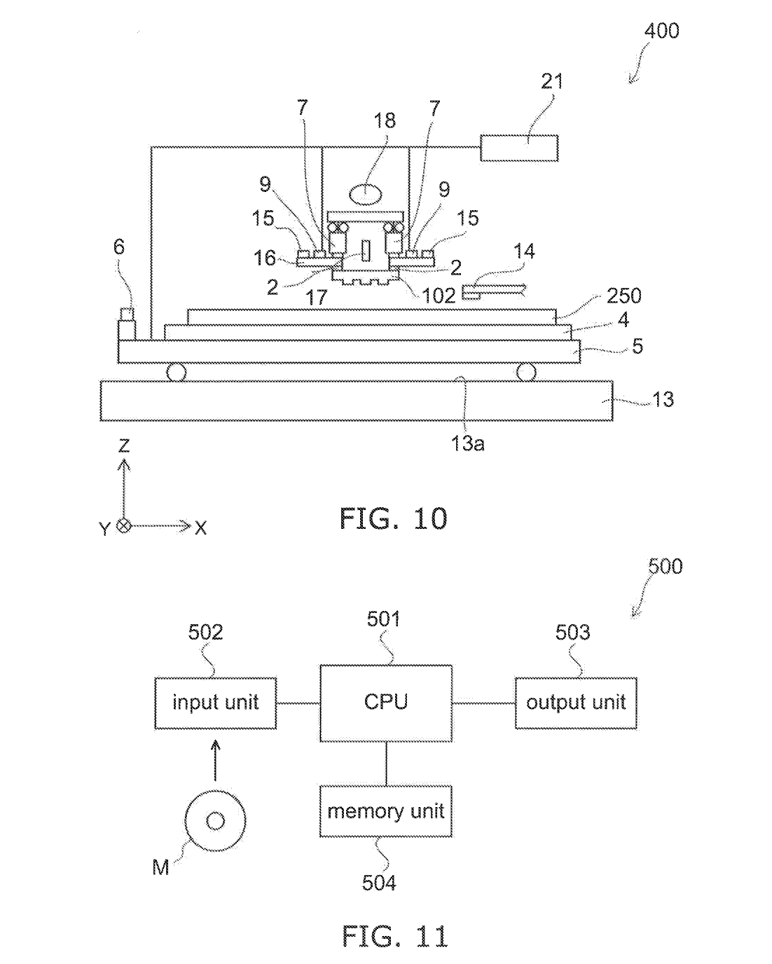

FIG. 10 is a schematic view illustrating a pattern formation apparatus according to the fourth embodiment.

A pattern formation apparatus 400 shown in FIG. 10 is an apparatus for performing the pattern formation method according to the third embodiment.

As shown in FIG. 10, the pattern formation apparatus 400 includes a master plate stage 2, a sample stage 5, a correction mechanism 9, a partial pressurization unit 17, a light source 18, and a control calculation unit 21. The pattern formation apparatus 400 further includes an alignment sensor 7 and an alignment stage 8. The pattern formation apparatus 400 according to the embodiment is an imprint apparatus that transfers the concave-convex configuration of the mold 102 to a photosensitive resin on the substrate 250.

A chuck 4 is provided on the sample stage 5. The chuck 4 holds the substrate 250. The chuck 4 holds the substrate 250 by vacuum suction, for example. The substrate 250 is a semiconductor substrate, for example.

The sample stage 5 is provided movably on a stage table 13. The sample stage 5 is provided movably along two axes along the upper surface 13a of the stage table 13. Here, the two axes along the upper surface 13a of the stage table 13 are defined as the X-axis and the Y-axis. The sample stage 5 is provided movably also along the Z-axis orthogonal to the X-axis and the Y-axis. The sample stage 5 is preferably provided rotatably about the X-axis, the Y-axis, and the Z-axis.

The sample stage 5 is provided with a fiducial mark base 6. A fiducial mark (not shown) serving as the fiducial position of the apparatus is provided on the fiducial mark base 6. The fiducial mark is used for the calibration of the alignment sensor 7 and the positioning of the mold 102 (posture control and adjustment). The fiducial mark is the origin on the sample stage 5. The X and Y coordinates of the substrate 250 mounted on the sample stage 5 are coordinates with the fiducial mark base 6 as the origin.

The master plate stage 2 fixes the mold 102. The master plate stage 2 holds the peripheral portion of the mold 102 by vacuum suction, for example. The mold 102 is formed of a material that transmits ultraviolet light, such as quartz and fluorite. The master plate stage 2 operates so as to position the mold 102 at the apparatus fiducial. The master plate stage 2 is attached to a base unit 16.

The base unit 16 is provided with the correction mechanism 9 (a correction means) and a pressurization unit 15 (a pressing means). The correction mechanism 9 includes an adjustment mechanism that makes fine adjustments to the position (posture) of the mold 102. The correction mechanism 9 corrects the relative positions of the mold 102 and the substrate 250 by making fine adjustments to the position (posture) of the mold 102. The correction mechanism 9 receives directions from the control calculation unit 21 to make fine adjustments to the position of the mold 102, for example.

The pressurization unit 15 applies pressure to the side surface of the mold 102 to correct the distortion of the mold 102. The pressurization unit 15 pressurizes the mold 102 from the four side surfaces of the mold 102 toward the center. The pressurization unit 15 receives directions from the control calculation unit 21 to pressurize the mold 102 with a prescribed stress, for example.

The partial pressurization unit 17 includes a mechanism that applies pressure partly to a prescribed position of the mold 102. The partial pressurization unit 17 includes a mechanism that applies air pressure to a specific position of a surface of the mold 102 on the base 10 side, a mechanism that brings a push rod (not shown) or the like into contact with a specific position to apply pressure partly, etc., for example. By pressure being partly applied to the mold 102 by the partial pressurization unit 17, the bending of the specific position of the mold 102 is adjusted.

The base unit 16 is attached to the alignment stage 8. The alignment stage 8 moves the base unit 16 in the X-axis direction and the Y-axis direction in order to make the alignment between the mold 102 and the substrate 250. The alignment stage 8 includes also a mechanism that rotates the base unit 16 along the XY plane. The direction of rotation along the XY plane is referred to as a θ direction.

The alignment sensor 7 detects an alignment mark provided on the mold 102 and an alignment mark provided on the substrate 250. The mold 102 is provided with a not-shown first alignment mark (a master plate alignment mark). On the underlayer pattern of the substrate 250, a not-shown second alignment mark (an underlayer alignment mark) is formed. The underlayer alignment mark and the master plate alignment mark are used to measure the relative misalignment between the mold 102 and the substrate 250.

The alignment sensor 7 detects the misalignment of the mold 102 to the fiducial mark on the fiducial mark base 6 and the misalignment of the substrate 250 to the mold 102. The position (e.g. the X and Y coordinates) of the alignment mark detected by the alignment sensor 7 is sent to the control calculation unit 21. Although only two alignment sensors 7 on the left and right sides are shown in FIG. 10, preferably there are four or more alignment sensors 7.

The control calculation unit 21 calculates the misalignment of the mold 102 to the fiducial mark mentioned above. The misalignment of the mold 102 to the fiducial mark mentioned above is detected in a state where the sample stage 5 is moved by a not-shown movement mechanism to a position where the fiducial mark mentioned above and the mold 102 can be detected simultaneously. The misalignment amount is acquired by applying light toward the fiducial mark mentioned above and the master plate alignment mark with a not-shown light source for alignment, and measuring the misalignment from the position of the center of gravity of the light that has returned to the alignment sensor 7 or the like.

The control calculation unit 21 produces a signal that controls the sample stage 5 in the X-axis direction, the Y-axis direction, the Z-axis direction, and the θ direction. The control calculation unit 21 produces a signal that controls the relative positions of the mold 102 and the sample stage 5. The position on the stage table 13 of the sample stage 5 is controlled by a signal sent from the control calculation unit 21, for example.

The control calculation unit 21 makes a calculation for making the alignment between the mold 102 and the substrate 250 based on the position information of the alignment mark sent from the alignment sensor 7. The alignment stage 8 makes the alignment adjustment between the mold 102 and the substrate 250 based on a signal sent from the control calculation unit 21.

The control calculation unit 21 may produce a signal that controls the correction mechanism 9. In order that stress for making the magnification correction of a master plate 1 may be generated in the pressurization unit 15, the control calculation unit 21 may give the pressurization unit 15 a signal for generating the stress by a prescribed calculation.

The control calculation unit 21 may control the light source 18. In the formation of a pattern by the imprint method, a photosensitive resin is applied onto the substrate 250, and then the photosensitive resin is irradiated with light from the light source 18 in a state where the mold 102 is kept in contact with the photosensitive resin. The control calculation unit 21 may control the timing of irradiation and the amount of irradiation of the light.

The light source 18 emits ultraviolet light, for example. The light source 18 is installed immediately above the mold 102, for example. The position of the light source 18 is not limited to immediately above the mold 102. In the case where the light source 18 is disposed in a position other than immediately above the mold 102, the configuration may be made such that an optical path is set using an optical member such as a mirror so that the light emitted from the light source 18 is applied from immediately above the mold 102 toward the mold 102.

The pattern formation apparatus 110 includes a coating apparatus 14. The coating apparatus 14 applies a photosensitive resin onto the substrate 250. The coating apparatus 14 has a nozzle, and drops the photosensitive resin onto the substrate 250 from the nozzle.

The pattern formation apparatus 400 forms a pattern in which the configuration of the concave-convex pattern of the mold 102 is transferred to the photosensitive resin on the substrate 250 by the imprint method. That is, in a state where the photosensitive resin is applied on the substrate 250, the bending of the mold 102 is adjusted by the partial pressurization unit 17, and in this state the distance in the Z-axis direction between the mold 102 and the substrate 250 is shortened to bring the mold 102 into contact with the photosensitive resin. Then, in this state, light is applied from the light source 18 to cure the photosensitive resin. After the curing of the photosensitive resin, the mold 102 is separated from the photosensitive resin. Thereby, a pattern in which the configuration of the concave-convex pattern of the mold 102 is transferred to the photosensitive resin is formed on the substrate 250.

When pattern formation by the imprint method is performed in the pattern formation apparatus 400, the adjustment of the bending of the mold 102 shown in the pattern formation method according to the third embodiment is achieved by the partial pressurization unit 17. Thereby, the difference between the film thickness of the photosensitive resin remaining in the space between the convex pattern feature of the mold 102 and the underlayer 260 and the film thickness of the reference is suppressed as compared to the case where the bending of the mold 102 is not adjusted. Thus, an accurate pattern is formed by using the pattern formation apparatus 400 according to the embodiment.

### Fifth Embodiment

Next, a fifth embodiment is described.

The fifth embodiment is a mold manufacturing program. The first acquisition unit 210, the second acquisition unit 220, and the data generation unit 230 of the mold manufacturing apparatus 200 shown in FIG. 7 can be provided as a program executed by a computer (a mold manufacturing program).

FIG. 11 is a diagram illustrating the hardware configuration of a computer.

A computer 500 includes a central processing unit 501, an input unit 502, an output unit 503, and a memory unit 504. The input unit 502 includes a function of reading information recorded in a recording medium M. For the mold manufacturing program, the processing of obtaining a first distribution performed in the first acquisition unit 210 (step S101 of FIG. 1), the processing of obtaining a second distribution performed in the second acquisition unit 220 (step S102 of FIG. 1), and the processing of generating correction data performed in the data generation unit 230 (step S103 of FIG. 1) are executed in the central processing unit 501 of the computer 500.

### Sixth Embodiment

The mold manufacturing program may be recorded on a computer-readable recording medium. The recording medium M stores the processing of obtaining a first distribution (step S101 of FIG. 1), the processing of obtaining a second distribution (step S102 of FIG. 1), and the processing of generating correction data (step S103 of FIG. 1) in a format readable by the computer 500. The recording medium M may be a memory device such as a server connected to a network. The mold manufacturing program may be delivered via a network.

As described above, the mold manufacturing method, the mold manufacturing apparatus, and the pattern formation method according to the embodiment can form a pattern accurately while suppressing the influence of a level difference of an underlayer.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. A mold manufacturing method comprising:
obtaining a first distribution which is a distribution of level difference included in a first layer on a substrate;
obtaining a second distribution which is a distribution of film thickness of a photosensitive resin remaining between the substrate and a convex pattern feature of a concave-convex pattern when a first mold having the concave-convex pattern is brought into contact with the photosensitive resin and the photosensitive resin is cured, the photosensitive resin being applied on the first layer;
generating a correction data for suppressing a difference between one of the first distribution and the second distribution, and a film thickness of a reference set beforehand; and
forming a second mold different from the first mold using the correction data.

2. The mold manufacturing method according to claim 1, wherein the obtaining the first distribution includes:
obtaining design data of an underlayer pattern included in the first layer; and
finding the first distribution showing a relationship between a position on the substrate and the level difference from the design data.

3. The mold manufacturing method according to claim 1, wherein the obtaining the first distribution includes finding the first distribution based on a result of measuring a level difference included in a reference layer equivalent to the first layer beforehand.

4. The mold manufacturing method according to claim 3, wherein the obtaining the first distribution includes referring to a table data found beforehand, the table data showing a relationship between a position on the substrate in the reference layer and a measurement result of a level difference included in the reference layer.

5. The mold manufacturing method according to claim 1, wherein the obtaining the second distribution includes finding a spacing between the first layer and the convex pattern feature based on a result of measuring a stress applied to the first mold beforehand.

6. The mold manufacturing method according to claim 1, wherein the obtaining the second distribution includes finding the second distribution by simulation from design data of the first mold and a stress applied to the first mold.

7. The mold manufacturing method according to claim 1, wherein the forming the second mold includes correcting a size of a concave-convex pattern feature of the first mold.

8. The mold manufacturing method according to claim 1, wherein the forming the second mold includes correcting a depth of a concave pattern feature of the first mold.

9. The mold manufacturing method according to claim 1, wherein the forming the second mold includes correcting a thickness of a base of the first mold.

10. The mold manufacturing method according to claim 1, wherein the forming the second mold includes forming an adjustment portion configured to adjust a bending of the first mold.

11. The mold manufacturing method according to claim 10, wherein the adjustment portion includes a recess provided in part of a base of the second mold.

12. The mold manufacturing method according to claim 10, wherein the adjustment portion includes a V trench provided in part of a base of the second mold.

13. The mold manufacturing method according to claim 1, wherein the forming the second mold includes forming the second mold using a composition different from a composition of the first mold.

14. A mold manufacturing apparatus comprising:
a first acquisition unit configured to obtain a first distribution which is a distribution of level difference included in a layer on a substrate;
a second acquisition unit configured to obtain a second distribution which is a distribution of film thickness of a photosensitive resin remaining between the substrate and a convex pattern feature of a concave-convex pattern when a first mold having the concave-convex pattern is brought into contact with the photosensitive resin and the photosensitive resin is cured, the photosensitive resin being applied on the layer, the first layer; and
a data generation unit configured to generate data for forming a second mold different from the first mold so as to suppress a difference between one of the first distribution and the second distribution, and a film thickness of a reference set beforehand.

15. A pattern formation method comprising:
obtaining a first distribution which is a distribution of level difference included in a first layer on a substrate;
obtaining a second distribution which is a distribution of film thickness of a photosensitive resin remaining between the substrate and a convex pattern feature of a concave-convex pattern when a mold having the concave-convex pattern is brought into contact with the photosensitive resin and the photosensitive resin is cured, the photosensitive resin being applied on the layer, the first layer;
applying the photosensitive resin onto the substrate;
generating a correction data for suppressing a difference between one of the first distribution and the second distribution, and a film thickness of a reference set beforehand;
adjusting a bending of the mold using the correction data;
curing the photosensitive resin in a state where the mold adjusted in bending and the photosensitive resin are kept in contact; and
separating the mold from the photosensitive resin.

16. The pattern formation method according to claim 15, wherein the adjusting a bending includes setting a pressure applied to a portion of the mold higher than a pressure applied to another portion of the mold.
